(19) United States
(12) Patent Application Publication
(10) Pub. No.: US 2006/0092221 A1
(43) Pub. Date: May 4, 2006

(54) Printing method and apparatus for an ink-jet printer having a wide printhead

(75) Inventor: Jin-wook Jeong, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/265,106

(22) Filed: Nov. 3, 2005

(30) Foreign Application Priority Data
Nov. 4, 2004 (KR) 10-2004-0089215

(51) Int. Cl. B41J 2/155

(52) U.S. Cl. 347/42

(57) ABSTRACT

A printing method and apparatus therefor are provided for an ink-jet printer having a wide printhead. Printing data is received. First printing dots are formed on a printing medium by a horizontal pitch using nozzles arranged in a first row according to colors. Second printing dots are formed at a position between the first printing dots by the horizontal pitch using nozzles arranged in a second row, with respect to the received printing data.

### BACKGROUND OF THE INVENTION

This application claims the benefit under 35 U.S.C. § 119(a) of Korean Patent Application No. 10-2004-0089215, filed on Nov. 4, 2004, in the Korean Intellectual Property Office, the entire disclosure of which is hereby incorporated by reference.

### FIELD OF THE INVENTION

The present invention relates to a printing method and apparatus by which an image density and an image concentration are improved when printing on a printing medium using a printer having a printhead with a greater width than the width of a sheet of paper.

### DESCRIPTION OF THE RELATED ART

Generally, a printhead that ejects ink droplets of a predetermined color onto a sheet of paper is disposed under an ink cartridge of an ink-jet printer. To print on a printing medium, a carriage on which an ink cartridge is mounted moves in a main scanning direction and a sheet of paper is sequentially fed in a subscanning direction. To print with high resolution using a conventional ink-jet printer, a speed at which the carriage moves in the main scanning direction should be reduced.

However, when the carriage moves in the main scanning direction, the carriage may be shaken, thereby limiting the ability to print at high-resolution.

To prevent the carriage from moving, a wide printhead is disclosed in U.S. Pat. No. 5,469,199. In the wide printhead, nozzles of a printhead are disposed along the width of a paper. When an image with high resolution is printed using the wide printhead, a printing speed is determined according to a line-feeding speed in a subscanning direction. Thus, a printing speed with high resolution may be increased. Additionally, since ink is ejected from a printhead fixed to a printer, precise printing is performed.

FIG. 1 illustrates an array of dots of ink printed on a printing medium in one swath of a conventional wide printhead. Referring to FIG. 1, dots of ink of each color, such as yellow (Y), magenta (M), cyan (C), and black (K), are disposed in one row. Dots of ink of the same color are arranged in a main scanning direction with a predetermined resolution, for example, 1200 dpi.

FIG. 2 illustrates an array of dots of ink printed on a printing medium in a normal mode, a draft mode, and a best mode using the conventional wide printhead forming the array of dots of ink shown in FIG. 1. In FIG. 2, only dots of ink from one color nozzle are shown for the convenience of explanation.

Referring to FIG. 2, to print in a normal mode 2A, a draft mode 2B, and a best mode 2C, a sheet of paper is fed by a 1 pitch (Pv), a 2 pitch (2 Pv), and half pitch (½ Pv) of a vertical pitch that form a predetermined resolution, for example, 1200 dpi, in a subscanning direction, respectively.

However, it may be seen that white appears on a printing medium even in a best mode 2C including a normal mode 2A and a draft mode 2B.

When printing is performed using a conventional ink-jet printer, ejected ink is spread onto the printing medium and the size of a dot of ink increases, an image density is high in both the normal mode and the best mode.

However, since the size of a dot of ink ejected from a wide printhead with high resolution is small, a printing area of the printing medium is not sufficiently covered by the dot of ink, and thus, areas of white may occur. In other words, an image density is low. Additionally, because the amount of ink required for forming dots of ink is small, an image concentration is low. Meanwhile, to increase the amount of ink ejected from the printhead with high resolution, power to be supplied to each nozzle should be increased. This results in overheating of nozzles and thus, there is a difficulty in increasing the power to be supplied to each nozzle.

FIG. 3 illustrates an array of dots of ink printed on a printing medium in one swath of a wide printhead in which nozzles of each color are disposed in two rows. Referring to FIG. 3, dots of ink of each color such as yellow (Y), magenta (M), cyan (C), and black (K), are disposed in two rows. Dots of ink of each color are arranged in a main scanning direction with a predetermined resolution, for example, 1200 dpi.

Dots of ink of each color in first and second rows are disposed in a subscanning direction with a predetermined resolution, for example, 1200 dpi.

FIG. 4 illustrates an array of dots of ink printed on a printing medium in a normal mode, a draft mode, and a best mode using a wide printhead forming the array of dots of ink shown in FIG. 3. In FIG. 4, only dots of ink from one color nozzle are shown for the convenience of explanation.

Referring to FIG. 4, to print in a normal mode 4A, a draft mode 4B, and a best mode 4C, a sheet of paper is fed by a 1 pitch (Pv), a 2 pitch (2 Pv), and half pitch (½ Pv) of a vertical pitch that form a predetermined resolution, for example, 1200 dpi, in a subscanning direction, respectively. An image density in the normal mode 4A is the same as an image density in the draft mode 4B. However, since one dot of ink is repeatedly printed using nozzles arranged in first and second rows, an image concentration in the normal mode 4A increases. Additionally, an image density in the best mode 4C is the same as an image density in the best mode 2C shown in FIG. 2, but an image concentration in the best mode 4C increases. In this way, even when printing is performed using a wide printhead having nozzles arranged in two rows, an image density does not improve.

Accordingly, a need exists for a printing method and apparatus for a printer having a wide printhead that increases the quality of the printed image.

### SUMMARY OF THE INVENTION

The present invention provides a printing method for a printer having a wide printhead by which the concentration of a printed image is improved.

The present invention also provides a printer having a wide printhead to increase the concentration of a printed image.

According to an aspect of the present invention, a printing method for an ink-jet printer having a wide printhead in which nozzles of different colors are arranged in a plurality of rows. The method includes (a) receiving printing data; and (b) forming first printing dots on a printing medium by a horizontal pitch using nozzles arranged in a first row according to colors and forming second printing dots at a position between the first printing dots by the horizontal pitch using nozzles arranged in a second row with respect to the received printing data.

The step (b) may include feeding the printing medium by a vertical pitch between the nozzles arranged in the first row and the nozzles arranged in the second row to perform printing in a normal mode, and performing printing on the printing medium using the nozzles arranged in the first row and the second row.

The step (b) may further include printing a first printing of the printing medium using the nozzles arranged in the first row that meet the printing medium first, and printing a last printing of the printing medium using the nozzles arranged in the second row.

The step (b) may further include feeding the printing medium by a pitch that corresponds to twice a vertical pitch between the nozzles arranged in the first row and the nozzles arranged in the second row to perform printing in a draft mode, and performing printing on the printing medium using the nozzles arranged in the first row and the second row.

The step (b) may further include feeding the printing medium by a half vertical pitch between the nozzles arranged in the first row and the nozzles arranged in the second row to perform printing in a best mode, performing printing on the printing medium using the nozzles arranged in the first row, feeding the printing medium by half of the vertical pitch, and performing printing on the printing medium using the nozzles arranged in the second row.

The step (b) may include feeding the printing medium by half of a vertical pitch between the nozzles arranged in the first row and the nozzles arranged in the second row to perform printing in a best mode, and performing printing on the printing medium using the nozzles arranged in the first row and the second row.

According to another aspect of the present invention, an ink-jet printer has a wide printhead in which nozzles of each color are arranged in two rows. The nozzles of the printhead are arranged in two rows according to colors. Nozzles are arranged in a first row by a horizontal pitch. Nozzles are arranged in a second row, which substantially correspond to the nozzles arranged in the first, and are shifted by half of the horizontal pitch from the nozzles arranged in the first row.

A vertical pitch between the nozzles in the first row and the nozzles in the second row, which substantially correspond to the nozzles in the first row, may be the same as the horizontal pitch or multiples of the horizontal pitch.

The nozzles in the first row and the nozzles in the second row, respectively, may be disposed in a straight line in a main scanning direction.

There may be a plurality of nozzle plates at which the nozzles in the first row and the nozzles in the second row are formed, and the nozzle plates may be disposed in a plurality of rows.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above aspects and advantages of the present invention will become more apparent by describing in detail exemplary embodiments thereof with reference to the attached drawings, in which:

FIG. 1 illustrates an array of dots of ink printed on a printing medium in one swath of a conventional wide printhead;

FIG. 2 illustrates an array of dots of ink printed on a printing medium in a normal mode (2A), a draft mode (2B), and a best mode (2C) using the conventional wide printhead for forming the array of dots of ink shown in FIG. 1;

FIG. 3 illustrates an array of dots of ink printed on a printing medium in one swath of a conventional wide printhead in which nozzles of each color are disposed in two rows;

FIG. 4 illustrates an array of dots of ink printed on a printing medium in a normal mode (4A), a draft mode (4B), and a best mode (4C) using a wide printhead forming the array of dots of ink shown in FIG. 3;

FIG. 5 illustrates an array of dots of ink printed on a printing medium in one swath of a wide printhead according to an exemplary embodiment of the present invention;

FIG. 6 illustrates an array of dots of ink printed on a printing medium in a normal mode (6A), a draft mode (6B), and a best mode (6C and 6D) using a wide printhead forming the array of dots of ink shown in FIG. 5;

FIG. 7 is a flowchart illustrating a printing method for an ink-jet printer having a wide printhead according to an exemplary embodiment of the present invention;

FIG. 8 illustrates a normal mode of a stepwise printing method;

FIG. 9 illustrates a draft mode of a stepwise printing method;

FIG. 10 is a schematic plan view illustrating a part of a structure of an ink-jet printer having a wide printhead according to an exemplary embodiment of the present invention;

FIG. 11 illustrates a wide printhead according to another embodiment of the present invention; and

FIG. 12 illustrates a wide printhead according to another exemplary embodiment of the present invention.

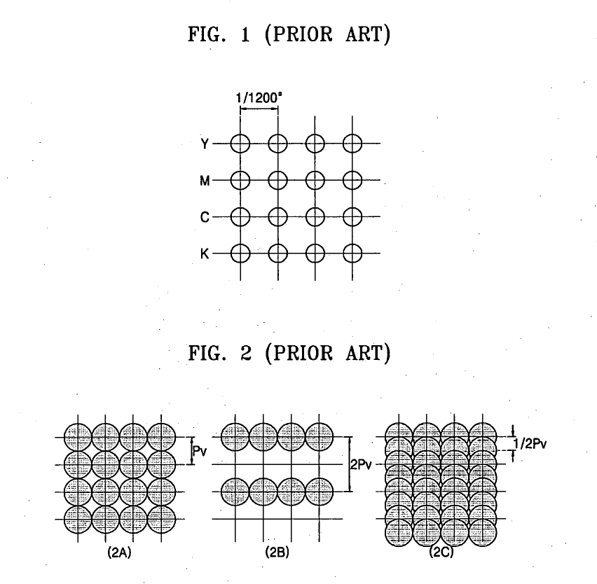

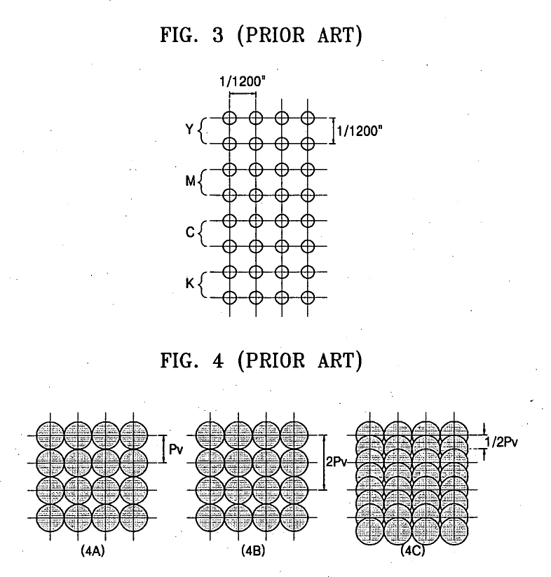

Throughout the drawings, like reference numerals will be understood to refer to like parts, components and structures.

### DETAILED DESCRIPTION OF EXEMPLARY EMBODIMENTS

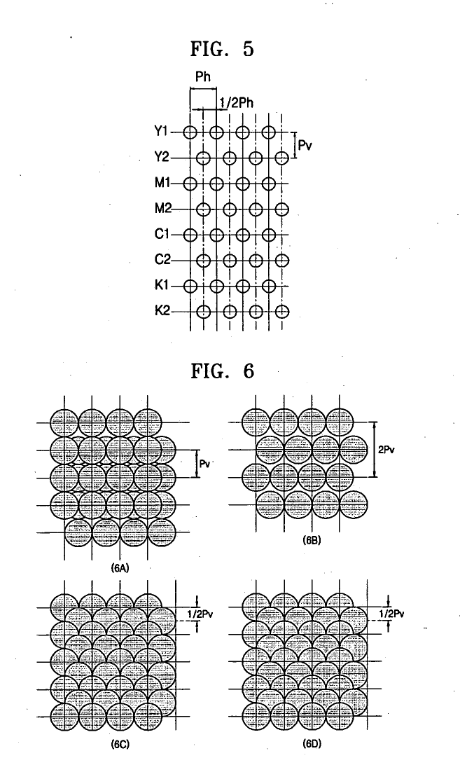

FIG. 5 illustrates an array of dots of ink printed on a printing medium in one swath of a wide printhead according to an exemplary embodiment of the present invention. Referring to FIG. 5, dots of ink of colors, such as yellow (Y), magenta (M), cyan (C), and black (K), are sequentially disposed. Dots of ink Y1, M1, C1, and K1 arranged in a first row and dots of ink Y2, M2, C2, and K2 arranged in a second row are arranged in a main scanning direction by a horizontal pitch Ph with a predetermined resolution, for example, 1200 dpi. Additionally, the dots of ink Y2, M2, C2, and K2 in the second row are shifted by half of the horizontal pitch Ph in the main scanning direction from the dots of ink Y1, M1, C1, and K1 in the first row.

The dots of ink in the first row and the dots of ink in the second row of each color are disposed by a vertical pitch Pv with a predetermined resolution, for example, 1200 dpi.

FIG. 6 illustrates an array of dots of ink printed on a printing medium in a normal mode, a draft mode, and a best mode using a wide printhead forming the array of dots of ink shown in FIG. 5. In FIG. 6, only dots of ink from one color nozzle are shown for the convenience of explanation.

Referring to FIG. 6, in order to print in a normal mode 6A, a draft mode 6B, and a best mode 6C and 6D, a sheet of paper is fed by a 1 pitch (Pv), a 2 pitch (2 Pv), and a half pitch (½ Pv) of a vertical pitch (Pv) that form a predetermined resolution, for example, 1200 dpi, in a subscanning direction, respectively.

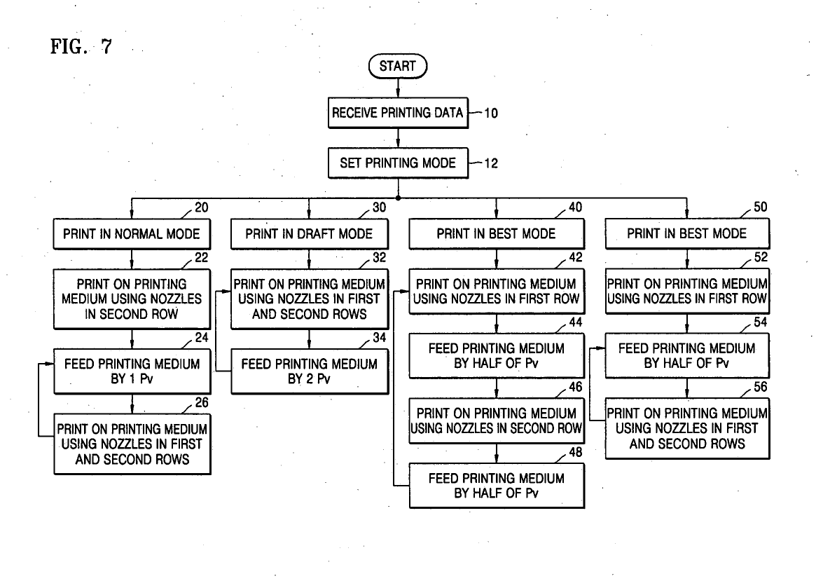

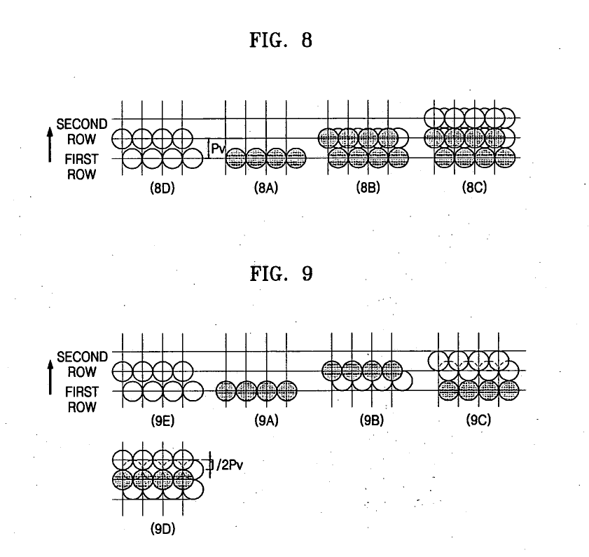

FIG. 7 is a flowchart illustrating a printing method for an ink-jet printer having a wide printhead according to an exemplary embodiment of the present invention.

First, in operation 10, printing data is received from a host computer connected directly or via a network to the ink-jet printer.

Subsequently, in operation 12, a printing mode is set for the received printing data. The printing mode includes a normal mode, a draft mode, and a best mode.

When printing is performed in a normal mode (6A of FIG. 6) in operation 20, as shown in 8A of FIG. 8, printing is performed on a printing medium using nozzles arranged in a first row in operation 22. Here, 8D of FIG. 8 illustrates the position of dots of ink to be formed on a printing medium when printing is performed using nozzles arranged in a first row and nozzles arranged in a second row, and an arrow represents a feeding direction of a sheet of paper.

Subsequently, in operation 24, the printing medium is fed by a 1 vertical pitch (Pv).

Subsequently, in operation 26, printing is performed on the printing medium using the nozzles arranged in the first row and the nozzles arranged in the second row, as shown in 8B of FIG. 8. Here, dots of ink are indicated by white circles in operation 22 and by gray circles in operation 24.

Subsequently, as shown in 8C of FIG. 8, operations 24 and 26 are repeatedly performed. Here, dots of ink are indicated by white circles in the previous operation, and dots of ink are indicated by gray circles in the present operation. A last line of the printing medium is printed using the nozzles arranged in the first row in the previous operation and using the nozzles arranged in the second row in the present operation.

A first printing and a last printing of the printing medium use only the nozzles in the first row and the nozzles in the second row, respectively, for the purpose of repeatedly printing the first and last lines of the printing medium using the nozzles in the first row and the nozzles in the second row.

The normal mode printing 6A according to an exemplary embodiment of the present invention is the same as the conventional normal mode printing 4A in that each line of the printing medium is printed using the nozzles in the first row and the nozzles in the second row. However, image density is improved.

When printing is performed in a draft mode (6B of FIG. 6) in operation 30, first, printing is performed on the printing medium using the nozzles in the first row and the nozzles in the second row in operation 32.

Subsequently, the printing medium is fed by a 2 vertical pitch (Pv) in operation 34.

Subsequently, operations 32 and 34 are repeatedly performed.

The draft mode printing 6B according to an exemplary embodiment of the present invention is the same as conventional draft mode printing 4B in that each line of the printing medium is printed using the nozzles in the first row or the nozzles in the second row. However, image density in the draft mode 6B is the same as that in the draft mode 4B but the amount of white area (that is, non-printed area) is reduced.

When printing is performed in a best mode (6C of FIG. 6) in operation 40, as shown in 9A of FIG. 9, printing is performed on a printing medium using nozzles arranged in a first row in operation 42. 9E of FIG. 9 illustrates the position of dots of ink to be formed on a printing medium when printing is performed using nozzles arranged in a first row and nozzles arranged in a second row, respectively, and an arrow represents a feeding direction of a sheet of paper.

Subsequently, in operation 44, the printing medium is fed by half of a vertical pitch (Pv).

Subsequently, in operation 46, printing is performed on the printing medium using the nozzles in a second row, as shown in 9B of FIG. 9. Here, dots of ink are indicated by white circles in operation 42 and by gray circles in operation 44.

Subsequently, the printing medium is fed by half of a vertical pitch (Pv) in operation 48.

Subsequently, as shown in 9C of FIG. 9, operation 44 is repeatedly performed. Here, dots of ink are indicated by white circles in the previous operation and by gray circles in the present operation.

9D of FIG. 9 illustrates a result of repeatedly performing operations 46 and 48.

A last printing of the printing medium may be printed using the nozzles in the second row.

The best mode printing 6C according to an exemplary embodiment of the present invention is performed with the same image concentration as that of a conventional best mode printing 4C. However, image density is greatly improved.

There is a difference between the best modes 6C and 6D of FIG. 6 in that in the best mode printing 6C of FIG. 6, nozzles arranged in one row are used during one swath printing and in the best mode printing 6D of FIG. 6, nozzles arranged in two rows are used during one swath printing. When printing is performed in the best mode 6D of FIG. 6 in operation 50, first, printing is performed on the printing medium using the nozzles in the first row in operation 52.

Subsequently, the printing medium is fed by half of a vertical pitch (Pv).

Subsequently, printing is performed on the printing medium using the nozzles in the first row and the nozzles in the second row in operation 56.

Subsequently, operations 54 and 56 are repeatedly performed.

Meanwhile, a last printing may be performed using the nozzles in the second row.

The other best mode printing 6D according to an exemplary embodiment of the present invention is performed with the same image density as that of the best mode printing 6C. However, the image concentration increases twofold.

A wide printhead for an ink-jet printer having a wide printhead according to an exemplary embodiment of the present invention is described with reference to the accompanying drawings.

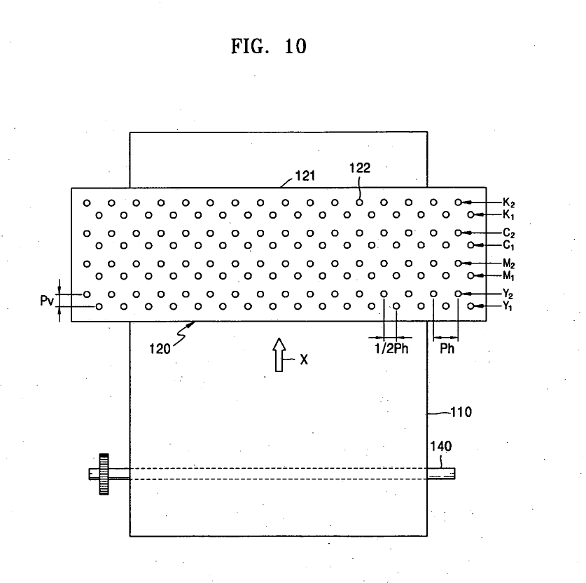

FIG. 10 is a schematic plan view illustrating a part of a structure of an ink-jet printer having a wide printhead according to an exemplary embodiment of the present invention. Referring to FIG. 10, a wide printhead 120 and a feeding roller 140 are sequentially disposed in a direction indicated by an arrow X, which is a feeding direction of a sheet of paper 110. A line feeding distance of a sheet of paper 110 to be placed under the wide printhead 120 is controlled by driving of the feeding roller 140.

Nozzles 122 through which yellow (Y) ink, magenta (M) ink, cyan (C) ink, and black (B) ink are ejected are arranged at a nozzle plate 121 of the wide printhead 120. The nozzles 122 for each color are disposed in two rows. Nozzles arranged in a first row and nozzles arranged in a second row are horizontally separated by a horizontal pitch (Ph) with horizontal resolution, respectively, and the nozzles in the second row are disposed to be shifted by half of a horizontal pitch (Ph) from the nozzles in the first row. The nozzles in a subscanning direction are disposed in the order of first and second rows Y1 and Y2 of yellow nozzles, first and second rows M1 and M2 of magenta nozzles, first and second rows C1 and C2 of cyan nozzles, and first and second rows K1 and K2 of black nozzles.

Although only one nozzle plate 121 is shown in FIG. 10, a nozzle plate 121 may be provided for each separate color, and a plurality of nozzle plates 121 may be provided for each separate color.

Color nozzles arranged in a first row and color nozzles arranged in a second row, which correspond to the nozzles arranged in the first row, may be vertically separated by a vertical pitch (Pv) having the same length as that of a horizontal pitch (Ph).

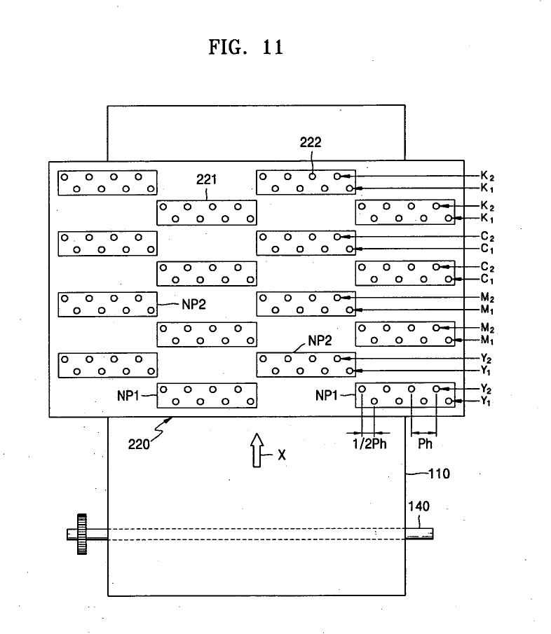

FIG. 11 illustrates a wide printhead according to another exemplary embodiment of the present invention. Referring to FIG. 11, a plurality of nozzle plates 221, from which yellow (Y) ink, magenta (M) ink, cyan (C) ink, and black (K) ink are ejected, are disposed in a wide printhead 220. Four nozzle plates 221 for each color overlap with one another substantially perpendicularly to the X direction, which is a feeding direction of a sheet of paper (subscanning direction).

Nozzles 222 for each color are disposed in two rows. Nozzles arranged in a first row and nozzles arranged in a second row, respectively, are separated by a horizontal pitch (Ph) with horizontal resolution, and nozzles arranged in the second row are disposed to be separated by half of a horizontal pitch (Ph) from the nozzles arranged in the first row. The nozzles 222 in the subscanning direction are disposed in the order of first and second rows Y1 and Y2 of yellow nozzles, first and second rows M1 and M2 of magenta nozzles, first and second rows C1 and C2 of cyan nozzles, and first and second rows K1 and K2 of black nozzles. When printing is performed using the wide printhead 220 with this arrangement, an image is printed through the nozzles 222 at a first nozzle plate NP1 first, and an image is printed through the nozzles 222 at a second nozzle plate NP2 after a printing medium is moved by a distance between nozzles arranged in the same row of the first and second nozzle plates NP1 and NP2.

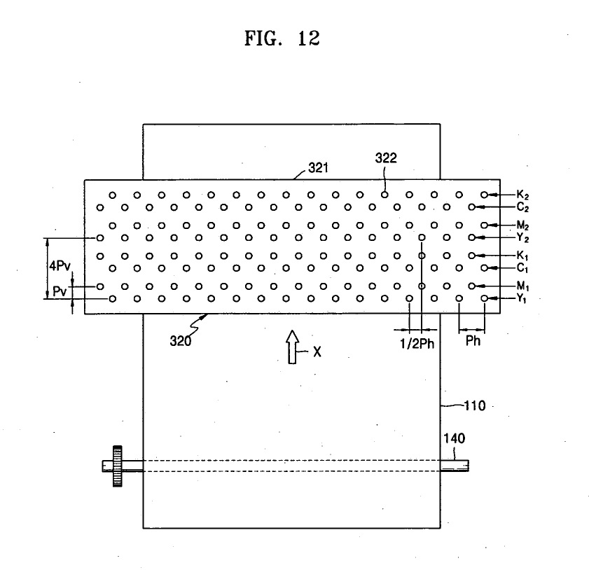

FIG. 12 illustrates a wide printhead according to another exemplary embodiment of the present invention. Referring to FIG. 12, a plurality of nozzles 322 through which yellow (Y) ink, magenta (M) ink, cyan (C) ink, and black (K) ink are ejected are disposed at a nozzle plate 321 of a wide printhead 320. Nozzles 322 for each color are disposed in two rows. Nozzles arranged in a first row and nozzles arranged in a second row of each color, respectively, are disposed by a horizontal pitch (Ph) with horizontal resolution, and nozzles arranged in the second row are disposed to be shifted by half of a horizontal pitch (Ph) from the nozzles arranged in the first row. The nozzles in the subscanning direction are disposed in the order of a first row Y1 of yellow nozzles, a first row M1 of magenta nozzles, a first row C1 of cyan nozzles, a first row K1 of black nozzles, a second row Y2 of yellow nozzles, a second row M2 of magenta nozzles, a second row C2 of cyan nozzles, and a second row K2 of black nozzles.

The nozzle plates 321 may be provided for each of the different color nozzles, and a plurality of nozzle plates may be provided for each of the color nozzles.

In a main scanning direction, the nozzles 322 may be separated by a predetermined vertical pitch (Pv). Nozzles of each color arranged in the first row and nozzles of each color arranged in the second row, which substantially correspond to the nozzles of each color arranged in the first row, may be formed by an integer multiple of the vertical pitch (Pv). For example, the separation distance may be a four-time vertical pitch (4 Pv).

As described above, in the printing method and apparatus for an ink-jet printer having a wide printhead according to exemplary embodiments of the present invention, an image density on a printing medium is improved.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A printing method for an ink-jet printer having a wide printhead in which nozzles of different colors are arranged in a plurality of rows, the method comprising
(a) receiving printing data; and
(b) forming first printing dots on a printing medium that are separated by a horizontal pitch using nozzles arranged in a first row according to a nozzle color and forming second printing dots at a position between the first printing dots by the horizontal pitch using nozzles arranged in a second row with respect to the received printing data.

2. The method of claim 1, wherein the step (b) comprises
feeding the printing medium by a distance corresponding to a vertical pitch between the nozzles arranged in the first row and the nozzles arranged in the second row to perform printing in a normal mode; and
performing printing on the printing medium using the nozzles arranged in the first row and the second row.

3. The method of claim 2, wherein the step (b) further comprises
printing a first printing of the printing medium using the nozzles arranged in the first row that meet the printing medium first; and
printing a last printing of the printing medium using the nozzles arranged in the second row.

4. The method of claim 1, wherein the step (b) further comprises
feeding the printing medium by a pitch that corresponds to twice a distance corresponding to a vertical pitch between the nozzles arranged in the first row and the nozzles arranged in the second row to perform printing in a draft mode; and
performing printing on the printing medium using the nozzles arranged in the first row and the second row.

5. The method of claim 4, wherein the step (b) comprises
feeding the printing medium by a distance corresponding to half of the vertical pitch between the nozzles arranged in the first row and the nozzles arranged in the second row to perform printing in a best mode;
performing printing on the printing medium using the nozzles arranged in the first row;
feeding the printing medium by half of the vertical pitch; and
performing printing on the printing medium using the nozzles arranged in the second row.

6. The method of claim 5, wherein the step (b) further comprises
printing a first printing of the printing medium using the nozzles arranged in the first row that meet the printing medium first; and
printing a last printing of the printing medium using the nozzles arranged in the second row.

7. The method of claim 1, wherein the step (b) comprises
feeding the printing medium by a distance corresponding to half of a vertical pitch between the nozzles arranged in the first row and the nozzles arranged in the second row to perform printing in a best mode; and
performing printing on the printing medium using the nozzles arranged in the first row and the second row.

8. The method of claim 7, wherein the step (b) further comprises
printing a first printing of the printing medium using the nozzles arranged in the first row that meet the printing medium first; and
printing a last printing of the printing medium using the nozzles arranged in the second row.

9. An ink-jet printer having a wide printhead in which nozzles of each color are arranged in two rows, wherein the nozzles of the printhead arranged in the two rows according to their respective colors comprises:
a plurality of nozzles arranged in a first row and separated by a horizontal pitch; and
a plurality of nozzles arranged in a second row that substantially correspond to the nozzles arranged in the first row and are shifted by half of the horizontal pitch from the nozzles arranged in the first row.

10. The ink-jet printer of claim 9, wherein
a vertical pitch between the nozzles in the first row and the nozzles in the second row that substantially correspond to the nozzles in the first row is the same as the horizontal pitch.

11. The ink-jet printer of claim 9, wherein
a vertical pitch between the nozzles in the first row and the nozzles in the second row that substantially correspond to the nozzles in the first row is a multiple of the horizontal pitch.

12. The ink-jet printer of claim 10, wherein
the nozzles in the first row and the nozzles in the second row, respectively, are disposed in a substantially straight line in a main scanning direction.

13. The ink-jet printer of claim 10, wherein
the plurality of nozzles of the first and second rows are connected to a nozzle plate.

14. The ink-jet printer of claim 13, wherein
the plurality of nozzles of the first and second rows are connected to a plurality of nozzle plates.

15. The ink-jet printer of claim 14, wherein
the plurality of nozzle plates are disposed in a plurality of rows.

16. The ink-jet printer of claim 9, wherein
the plurality of nozzles of the first and second rows are arranged according to colors.

17. The ink-jet printer of claim 16, wherein
the plurality of nozzles are disposed in an order of cyan, cyan, magenta, magenta, yellow, yellow, black, and black.

18. The ink-jet printer of claim 16, wherein
the plurality of nozzles are disposed in an order of cyan, magenta, yellow, black, cyan, magenta, yellow, and black.
